(19) United States
(12) Patent Application Publication
(10) Pub. No.: US 2024/0037474 A1
(43) Pub. Date: Feb. 1, 2024

(54) CLEANING WORK ASSISTANCE SERVER, CLEANING WORK ASSISTANCE METHOD, AND COMPUTER-READABLE RECORDING MEDIUM

(71) Applicant: Global Gates Co., Ltd., Tokyo (JP)

(72) Inventors: Masayuki UMEMURA, Tokyo (JP); Jun NATSUYAMA, Tokyo (JP)

(73) Assignee: Global Gates Co., Ltd., Tokyo (JP)

(21) Appl. No.: 18/264,823

(22) PCT Filed: Apr. 7, 2022
(86) PCT No.: PCT/JP2022/017301

§ 371 Date: Aug. 9, 2023

(30) Foreign Application Priority Data
Apr. 9, 2021 (JP) 2021-066799

(51) Int. Cl. G06Q 10/0631; G06Q 50/12; G06Q 10/0633

(52) U.S. Cl. CPC G06Q 10/06316; G06Q 50/12; G06Q 10/0633; G06Q 10/063114; G06Q 10/06315

(57) ABSTRACT

If a headcount of workers on the one service day, the workers having been specified for one cleaning-assigned area that is assigned to one cleaning-service provider, is insufficient for a headcount that is necessary for a cleaning service on the one service day and that has been determined for the one cleaning-assigned area, one or more surplus workers who belong to another cleaning-service provider (workers who can work on the one service day and to whom none of cleaning services has been assigned) are allotted to resolve a shortage of staff for cleaning work in the one cleaning-assigned area.

### TECHNICAL FIELD

The present invention relates to a cleaning-service assistance server, a cleaning-service assistance method, and a computer-readable recording medium.

### BACKGROUND

In a plurality of areas in relatively-large accommodation facilities, a plurality of cleaning service providers may share cleaning services they provide for rooms. For example, at a hotel with a plurality of floors, in many cases, the cleaning service providers undertake the cleaning services in units of the floors. Rewards for the cleaning services are calculated generally on the basis of achievements of how many rooms they have cleaned.

### SUMMARY

When the cleaning service provider undertakes a cleaning service for a certain area (such as one of the floors), a headcount of staff who is necessary for this cleaning service varies depending on a room occupancy rate in this area. If a headcount of workers is significantly lower than the headcount of the necessary staff, cleaning of rooms in this assigned area may not be completed within a preset time period, or quality of the cleaning may be deteriorated. Meanwhile, if the headcount of the workers is significantly higher than the headcount of the necessary staff, profits decrease because labor cost is higher than the rewards for the cleaning service. In particular, in recent years, online accommodation-booking systems have facilitated booking and cancellation of accommodation. Thus, the room occupancy rate may fluctuate immediately before check-in dates, which makes it difficult to anticipate the variation of the headcount of the staff who is necessary for the cleaning service. The cleaning service providers cannot easily increase or reduce the number of workers they employ. Thus, the variation of the headcount of the staff who is necessary for the cleaning service due to the fluctuation of the room occupancy rate has been one of factors that make it difficult for the cleaning service providers to run their businesses.

The present invention has been made in view of such circumstances, and an object thereof is to provide a cleaning-service assistance server, a cleaning-service assistance method, and a computer-readable recording medium that enable cleaning service providers to properly provide their respective cleaning services even if headcounts of staff who is necessary for the cleaning services vary along with variation of a room occupancy rate.

According to a first aspect of the present invention, there is provided a cleaning-service assistance server that assists cleaning services which are provided by a plurality of cleaning service providers for rooms in accommodation facilities, the cleaning-service assistance server including:
a processing unit; and
a memory that stores an instruction which can be executed by the processing unit,
the processing unit being capable of making access to a database that stores work schedule information about work schedules of one or more workers who belong to the plurality of cleaning service providers,
the processing unit executing, in accordance with the instruction stored in the memory, a process including
   a first step of acquiring room-occupancy-rate information
      that is about room occupancy rates in one or more cleaning-assigned areas for which cleaning is assigned respectively to the plurality of cleaning service providers, and
      that is about, among the rooms in the accommodation facilities, rooms
         which are in the one or more cleaning-assigned areas, and
         which need to be cleaned on one service day among service days,
   a second step of determining respective headcounts of, among the one or more workers, workers who are necessary for the cleaning services for the one or more cleaning-assigned areas on the one service day, the respective headcounts being determined respectively for the one or more cleaning-assigned areas on a basis of the acquired room-occupancy-rate information,
   a third step of specifying which of the one or more workers is engaged in the cleaning services for the one or more cleaning-assigned areas on the one service day, the specifying being made for each of the one or more cleaning-assigned areas
      on a basis of a corresponding one headcount among the respective headcounts on the one service day, the respective headcounts having been determined respectively for the one or more cleaning-assigned areas, and
      on a basis of the work schedule information about the work schedules of the one or more workers who belong to the plurality of cleaning service providers, and
   a fourth step of allotting surplus workers to resolve a shortage of staff for cleaning work in one cleaning-assigned area among the one or more cleaning-assigned areas if a headcount of one or more workers on the one service day among the one or more workers, the one or more workers on the one service day having been specified for the one cleaning-assigned area, the one cleaning-assigned area having been assigned to one cleaning-service provider among the plurality of cleaning service providers, is insufficient for the corresponding one headcount on the one service day among the respective headcounts, the corresponding one headcount on the one service day having been determined for the one cleaning-assigned area, the surplus workers being another one or more workers
      who belong to another cleaning-service provider among the plurality of cleaning service providers,
      who can work on the one service day, and
      to whom none of the cleaning services has been assigned among the one or more workers who belong to the plurality of cleaning service providers,
priorities being set to a plurality of cleaning-assigned areas in one accommodation facility among the one or more cleaning-assigned areas in the accommodation facilities,
the processing unit executing the fourth step sequentially from cleaning-assigned areas with higher priorities among the plurality of cleaning-assigned areas with the priorities.

According to a second aspect of the present invention, there is provided a cleaning-service assistance method of assisting, by a server, cleaning services which are provided by a plurality of cleaning service providers for rooms in accommodation facilities,
the server being capable of making access to a database that stores work schedule information about work schedules of one or more workers who belong to the plurality of cleaning service providers,
the server including
   a first step of acquiring room-occupancy-rate information
      that is about room occupancy rates in one or more cleaning-assigned areas for which cleaning is assigned respectively to the plurality of cleaning service providers, and
      that is about, among the rooms in the accommodation facilities, rooms
         which are in the one or more cleaning-assigned areas, and
         which need to be cleaned on one service day among service days,
   a second step of determining respective headcounts of, among the one or more workers, workers who are necessary for the cleaning services for the one or more cleaning-assigned areas on the one service day, the respective headcounts being determined respectively for the one or more cleaning-assigned areas on a basis of the acquired room-occupancy-rate information,
   a third step of specifying which of the one or more workers is engaged in the cleaning services for the one or more cleaning-assigned areas on the one service day, the specifying being made for each of the one or more cleaning-assigned areas
      on a basis of a corresponding one headcount among the respective headcounts on the one service day, the respective headcounts having been determined respectively for the one or more cleaning-assigned areas, and
      on a basis of the work schedule information about the work schedules of the one or more workers who belong to the plurality of cleaning service providers, and
   a fourth step of allotting surplus workers to resolve a shortage of staff for cleaning work in one cleaning-assigned area among the one or more cleaning-assigned areas if a headcount of one or more workers on the one service day among the one or more workers, the one or more workers on the one service day having been specified for the one cleaning-assigned area, the one cleaning-assigned area having been assigned to one cleaning-service provider among the plurality of cleaning service providers, is insufficient for the corresponding one headcount on the one service day among the respective headcounts, the corresponding one headcount on the one service day having been determined for the one cleaning-assigned area, the surplus workers being another one or more workers
      who belong to another cleaning-service provider among the plurality of cleaning service providers,
      who can work on the one service day, and
      to whom none of the cleaning services has been assigned among the one or more workers who belong to the plurality of cleaning service providers,
priorities being set to a plurality of cleaning-assigned areas in one accommodation facility among the one or more cleaning-assigned areas in the accommodation facilities,
the server executing the fourth step sequentially from cleaning-assigned areas with higher priorities among the plurality of cleaning-assigned areas with the priorities.

According to a third aspect of the present invention, there is provided a computer-readable recording medium that records a cleaning-service assistance program for causing a server to execute a process of assisting cleaning services which are provided by a plurality of cleaning service providers for rooms in accommodation facilities,
the server being capable of making access to a database that stores work schedule information about work schedules of one or more workers who belong to the plurality of cleaning service providers,
the process that the cleaning-service assistance program causes the server to execute including
   a first step of acquiring room-occupancy-rate information
      that is about room occupancy rates in one or more cleaning-assigned areas for which cleaning is assigned respectively to the plurality of cleaning service providers, and
      that is about, among the rooms in the accommodation facilities, rooms
         which are in the one or more cleaning-assigned areas, and
         which need to be cleaned on one service day among service days,
   a second step of determining respective headcounts of, among the one or more workers, workers who are necessary for the cleaning services for the one or more cleaning-assigned areas on the one service day, the respective headcounts being determined respectively for the one or more cleaning-assigned areas on a basis of the acquired room-occupancy-rate information,
   a third step of specifying which of the one or more workers is engaged in the cleaning services for the one or more cleaning-assigned areas on the one service day, the specifying being made for each of the one or more cleaning-assigned areas
      on a basis of a corresponding one headcount among the respective headcounts on the one service day, the respective headcounts having been determined respectively for the one or more cleaning-assigned areas, and
      on a basis of the work schedule information about the work schedules of the one or more workers who belong to the plurality of cleaning service providers, and
   a fourth step of allotting surplus workers to resolve a shortage of staff for cleaning work in one cleaning-assigned area among the one or more cleaning-assigned areas if a headcount of one or more workers on the one service day among the one or more workers, the one or more workers on the one service day having been specified for the one cleaning-assigned area, the one cleaning-assigned area having been assigned to one cleaning-service provider among the plurality of cleaning service providers, is insufficient for the corresponding one headcount on the one service day among the respective headcounts, the corresponding one headcount on the one service day having been determined for the one cleaning-assigned area, the surplus workers being another one or more workers
      who belong to another cleaning-service provider among the plurality of cleaning service providers,
      who can work on the one service day, and
      to whom none of the cleaning services has been assigned among the one or more workers who belong to the plurality of cleaning service providers,
priorities being set to a plurality of cleaning-assigned areas in one accommodation facility among the one or more cleaning-assigned areas in the accommodation facilities,
the cleaning-service assistance program causing the server to execute the fourth step sequentially from cleaning-assigned areas with higher priorities among the plurality of cleaning-assigned areas with the priorities.

### Advantageous Effects of Invention

According to the present invention, it is possible to provide the cleaning-service assistance server, the cleaning-service assistance method, and the computer-readable recording medium that enable cleaning service providers to properly provide their respective cleaning services even if headcounts of staff who is necessary for the cleaning services vary along with variation of a room occupancy rate.

### BRIEF DESCRIPTION OF DRAWINGS

FIG. 1 is a diagram showing an example of a configuration of a cleaning-service assistance system according to an embodiment of the present invention.

FIG. 2 is a diagram showing an example of databases included in a database group.

FIG. 3 is an explanatory flowchart showing an example of a procedure of specifying which of workers does cleaning work in a cleaning assigned area that is assigned to one cleaning-service provider on one service day.

FIG. 4 is an explanatory flowchart showing an example of a procedure of allotting a surplus worker to resolve a shortage of staff.

FIG. 5 is an explanatory flowchart showing a modification of the procedure of allotting the surplus worker to resolve the shortage of staff.

### DETAILED DESCRIPTION OF EMBODIMENTS

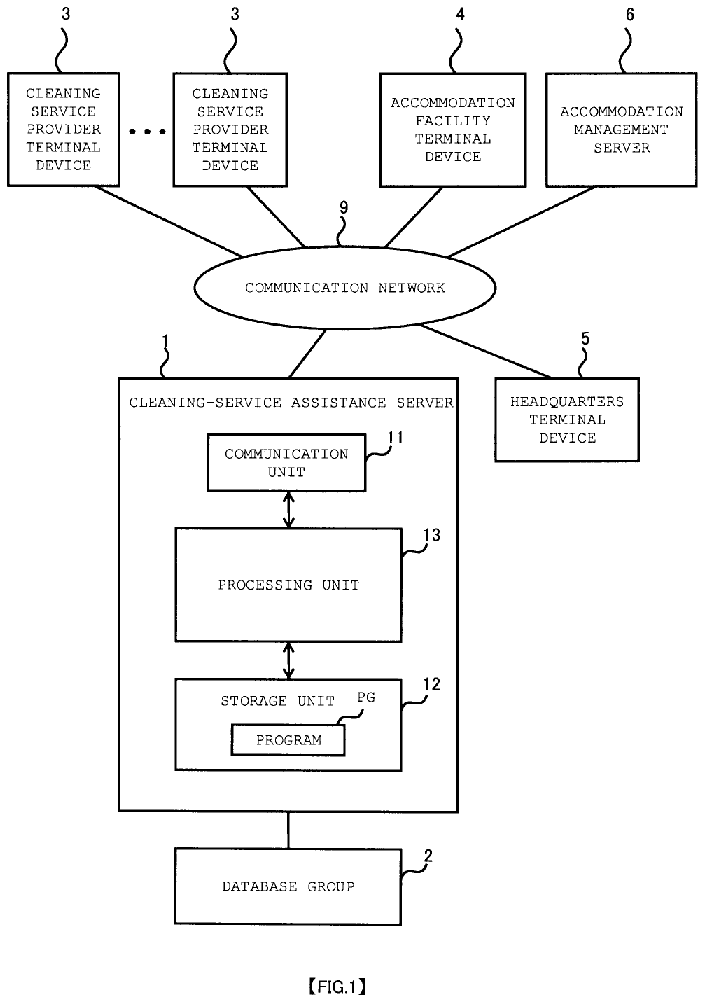

FIG. 1 is a diagram showing an example of a configuration of a cleaning-service assistance system according to an embodiment of the present invention. The cleaning-service assistance system exemplified in FIG. 1 includes a cleaning-service assistance server 1, a database group 2, a plurality of cleaning-service-provider terminal devices 3, one or more accommodation-facility terminal devices 4, a headquarters terminal device 5, and an accommodation management server 6. The cleaning-service assistance server 1, the accommodation management server 6, and the terminal devices (cleaning-service-provider terminal devices 3, accommodation-facility terminal device 4, and headquarters terminal device 5) are communicable with each other via a communication network 9 such as the Internet.

The cleaning-service-provider terminal devices 3 are devices having an information communication function, such as personal computers, tablets, or smartphones, and are operated from an accommodation facility by cleaning service providers that undertake cleaning services for rooms. The cleaning-service-provider terminal devices 3 make access to the cleaning-service assistance server 1. For example, the cleaning-service-provider terminal devices 3 register various information (such as information about the cleaning service providers, information about workers, information about work schedules, information about work achievements, information about details of the cleaning services, and information about achievements of the cleaning services) with databases of the database group 2, and transmit and receive notifications about borrowing of surplus workers described below.

The accommodation-facility terminal device 4 is a device having an information communication function, such as a personal computer, a tablet, or a smartphone, and is operated by a service provider that runs the accommodation facility. The accommodation-facility terminal device 4 makes access to the accommodation management server 6. For example, the accommodation-facility terminal device 4 displays booking statuses of the rooms (such as whether or not booking has been made for each day, and information about guests), and registers information about providing statuses of accommodation services (such as check-in and check-out) for the rooms. In addition, the accommodation-facility terminal device 4 makes access to the cleaning-service assistance server 1, registers information about rating of cleaning quality of the rooms, and displays information about attributes (such as cleaning skill) of the workers who are assigned to cleaning of the rooms.

The headquarters terminal device 5 is a device having an information communication function, such as a personal computer, a tablet, or a smartphone, and is operated by a service provider that assists the cleaning services by the plurality of cleaning service providers for the rooms in the accommodation facility (below, sometimes referred to as “headquarters”). The headquarters terminal device 5 makes access to the cleaning-service assistance server 1. For example, the headquarters terminal device 5 registers various information with the databases of the database group 2, and displays the information registered with these databases. In addition, the headquarters terminal device 5 transmits and receives notifications relevant to the assistance of the cleaning services to and from the cleaning-service-provider terminal devices 3 (specifically, receives help requests from a cleaning service provider that has become short of staff who is necessary for cleaning work, and transmits responses thereto).

The accommodation management server 6 is an apparatus that executes processes relating to management of services of providing the accommodation services in the one or more accommodation facilities. The accommodation management server 6 includes one or more computers connected to the communication network 9 (such as a computer group that provides cloud computing). The accommodation management server 6 is capable of making access to one or more databases that store, for example, information about the booking statuses of the rooms, the information about the providing statuses of the accommodation services for the rooms, and the information about the guests. The accommodation management server 6 executes a process of reading out the information from the databases and providing the information to the terminal devices in response to requests from these terminal devices, the terminal devices (such as accommodation-facility terminal device 4) making access via the communication network 9, and a process of writing information that has been entered to the terminal devices into the databases. In addition, the accommodation management server 6 executes a process of providing information about room occupancy rates in the accommodation facilities to the cleaning-service assistance server 1 in response to a request from the cleaning-service assistance server 1.

The cleaning-service assistance server 1 is an apparatus that executes processes of assisting the cleaning services by the plurality of cleaning service providers for the rooms in the accommodation facilities. The cleaning-service assistance server 1 includes one or more computers connected to the communication network 9 (such as a computer group that provides cloud computing). The cleaning-service assistance server 1 exemplified in FIG. 1 includes a communication unit 11, a storage unit 12, and a processing unit 13.

The communication unit 11 communicates with other devices (such as the cleaning-service-provider terminal devices 3, the accommodation-facility terminal device 4, the headquarters terminal device 5, and the accommodation management server 6) via the communication network 9. The communication unit 11 includes a device (such as network interface card) that performs the communication according to a predetermined communication standard such as Ethernet (trademark) or to that of wireless LAN.

The storage unit 12 stores one or more programs PG that include instructions which can be executed by the processing unit 13, and data to be used in the processes. The storage unit 12 may include an arbitrary storage device such as a DRAM, a flash memory, a hard disk, or an SSD. The storage unit 12 may include a plurality of storage devices that are connected to the processing unit 13 via a bus for the computers or other arbitrary communication means.

The processing unit 13 is a device that executes the processes in accordance with the instructions included in the one or more programs PG stored in the storage unit 12, and that includes one or more processors (such as CPUs, microprocessors, or DSPs). The processing unit 13 functions as the one or more computers by executing the processes in accordance with the instructions included in the one or more programs PG. The cleaning-service assistance server 1 may include such a plurality of computers, and these computers may execute the processes in cooperation with each other by communicating with each other via an arbitrary communication network. Note that, the processing unit 13 may execute some of the processes by using dedicated hardware (such as ASICs and FPGAs).

The one or more programs PG may be recorded, for example, in a computer-readable recording medium (such as an optical disk or a non-transitory tangible medium such as a USB flash drive). The processing unit 13 may load, via a recording-medium reading device (such as an optical disk drive or a USB interface) (not shown), at least some of the one or more programs PG recorded in such a recording medium, and may write these programs PG into the storage unit 12. Alternatively, the processing unit 13 may download, via the communication unit 11, some of the one or more programs PG from the other devices to be connected to the communication network 9, and may write these programs into the storage unit 12. The one or more programs PG include a program for causing the processing unit 13 to execute at least a part of a cleaning-service assistance procedure described below.

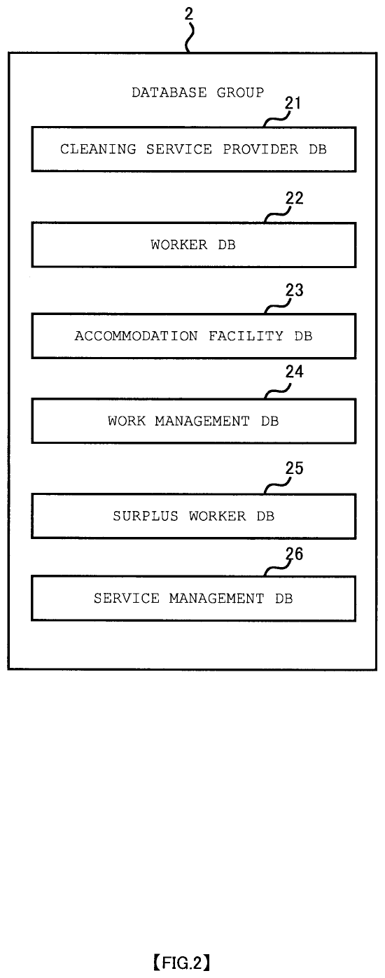

The database group 2 includes a plurality of databases (below, sometimes abbreviated as “DBs”) that are accessible to the cleaning-service assistance server 1. As shown in FIG. 2, the database group 2 includes a cleaning-service-provider DB 21, a worker DB 22, an accommodation facility DB 23, a work management DB 24, a surplus worker DB 25, and a service management DB 26.

The cleaning-service-provider DB 21 stores the information about the cleaning service providers that undertake the cleaning services for the rooms in the accommodation facilities, the information being stored to be searchable. The information about the cleaning service providers includes identification codes of the cleaning service providers, appellations of the cleaning service providers, their addresses and points of contact, and names of their persons in charge.

The worker DB 22 stores the information about the workers who do cleaning work of the rooms, the information being stored to be searchable. The information about the workers includes identification codes of the workers, names of the workers, their sexes, ages, addresses, and points of contact, and the information about the cleaning service providers to which the workers belong (such as the identification codes of the cleaning service providers), the attribute information about the cleaning skill of the workers, and information about accommodation facilities at which the workers can work (such as identification codes of the accommodation facilities).

The attribute information about the cleaning skill among items of the information to be stored in the worker DB 22 includes information that indicates ranks of the cleaning skill. In this case, the attribute information about the cleaning skill may indicate to which of the plurality of ranks that indicate levels of the cleaning skill the workers belong.

The accommodation facility DB 23 stores information about the accommodation facilities in which the cleaning services for the rooms are provided, the information being stored to be searchable. The information about the accommodation facilities includes the identification codes of the accommodation facilities, appellations of the accommodation facilities, their addresses and points of contact, and names of their persons in charge, and identification codes of cleaning assigned areas (such as floors), identification codes of the rooms, the information about the cleaning service providers that undertake cleaning services for the cleaning assigned areas (such as the identification codes of the cleaning service providers), information about normal work hours that are necessary for cleaning of each of the rooms, and information about scheduled work hours that are preset for the cleaning services for the rooms by the cleaning service providers.

The information about the work hours for the rooms among the items of the information to be stored in the accommodation facility DB 23 indicates, for example, normal work hours at a time when a worker having average cleaning skill according to the attribute information does cleaning.

The information about the scheduled work hours among the items of the information to be stored in the accommodation facility DB 23 indicates, for example, time periods that are preset for the cleaning work at the accommodation facilities. These scheduled work hours may be set in common for all the rooms in the accommodation facilities, may be set respectively for the cleaning assigned areas that are assigned respectively to the cleaning service providers, or may be set respectively for the rooms.

The work management DB 24 stores information about management of work by each of the workers, the information being stored to be searchable. The information about the management of the work includes the information about the work schedules of the workers on their service days, and the information about their work achievements.

The information about the work schedules (work schedule information) includes whether or not the workers have been scheduled to work, information about accommodation facilities at which the workers have been scheduled to work (such as the identification codes of the accommodation facilities).

The information about the work achievements (work achievement information) includes whether or not the workers have the work achievements, information about accommodation facilities at which the workers have ever worked (such as the identification codes of the accommodation facilities), and information about rooms that the workers have ever cleaned (such as the identification codes of the rooms).

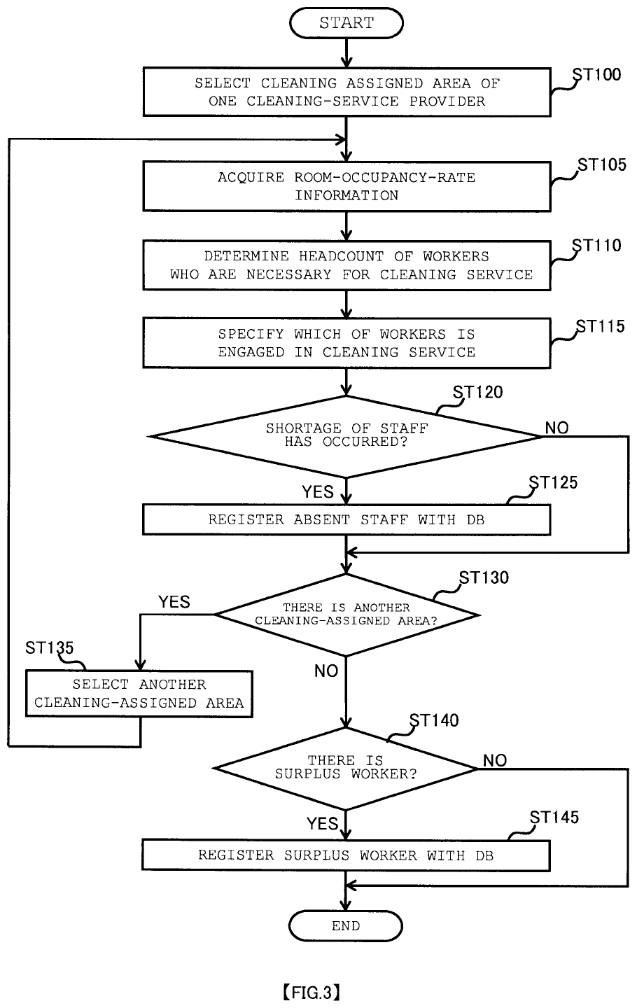

The surplus worker DB 25 stores information about the surplus workers that are specified by the procedure described below (FIG. 3), the information being stored to be searchable. The surplus worker DB 25 stores, for example, identification codes of the surplus workers on each of the service days, and information about accommodation facilities at which the surplus workers can work (such as the identification codes of the accommodation facilities).

The service management DB 26 stores information for managing the cleaning services by the cleaning service providers on their service days, the information being stored to be searchable. For example, the service management DB 26 may store information about the details of the cleaning services by the cleaning service providers on their service days. The information about the details of the cleaning services includes the information about the accommodation facilities and information about the cleaning assigned areas in which the cleaning services are provided (such as the identification codes of the accommodation facilities and the identification codes of the cleaning assigned areas).

Further, the service management DB 26 may store information about a necessary headcount of the workers who provide the cleaning services, the necessary headcount being determined by the procedure described below (FIG. 3), and information about absent staff who is specified by this procedure.

Still further, the service management DB 26 may store information about achievements of the cleaning services by the cleaning service providers on their service days. The information about the achievements of the cleaning services includes the identification codes of the accommodation facilities and the cleaning assigned areas in which the cleaning service providers have ever provided the cleaning services on their service days, and information about staff who has ever done the cleaning work (information about own staff, information about surplus workers borrowed from another cleaning-service provider among the cleaning service providers, and information about staff sent from the headquarters).

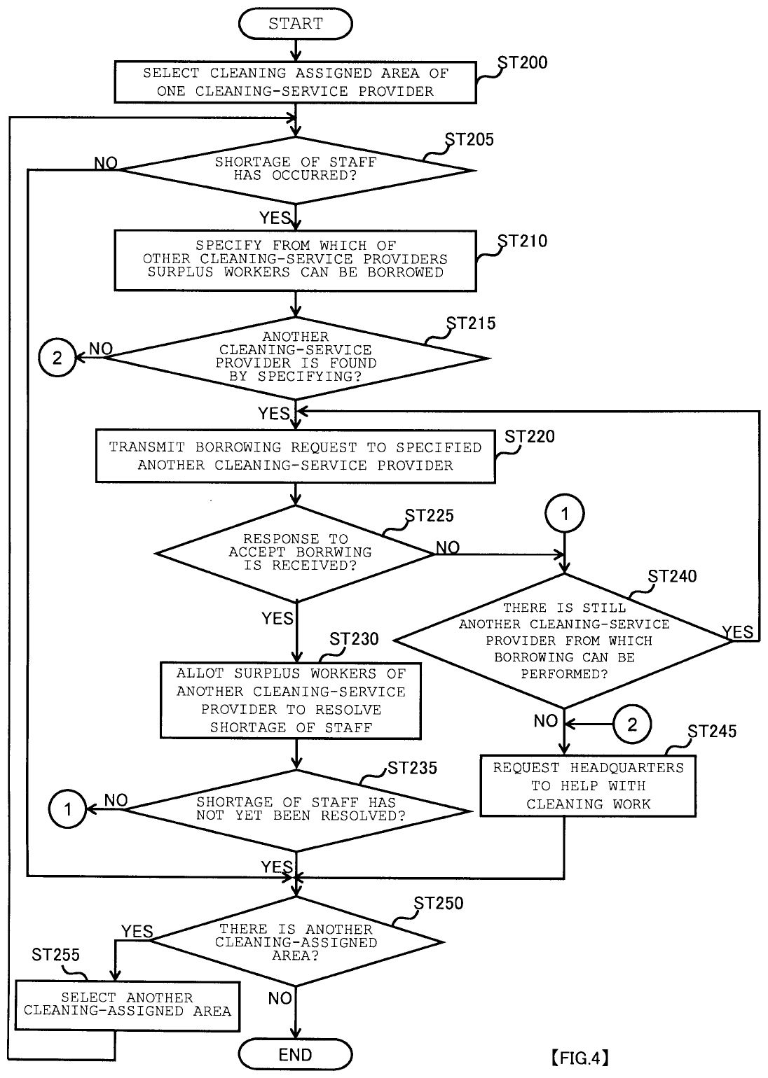

Now, the cleaning-service assistance procedure to be executed by the cleaning-service assistance server 1 having the configuration shown in FIG. 1 is described with reference to flowcharts of FIG. 3 and FIG. 4.

FIG. 3 is an explanatory flowchart showing an example of a procedure of specifying which of workers does cleaning work in a cleaning assigned area that is assigned to a certain one cleaning-service provider among the cleaning service providers on a certain-one service day among service days.

First, the processing unit 13 of the cleaning-service assistance server 1 selects one cleaning-assigned area that is assigned to the certain one cleaning-service provider from among the cleaning assigned areas (for example, one of floors of an accommodation facility) (ST100), and acquires information about a room occupancy rate in the selected cleaning-assigned area (room-occupancy-rate information) (ST105). The room-occupancy-rate information is, for example, information about rooms that need to be cleaned in the selected cleaning-assigned area (for example, in the one of the floors) on the certain-one service day (that is, rooms used by guests). The room-occupancy-rate information may be, for example, information that indicates the number of rooms that need to be cleaned, or identification codes of these rooms that need to be cleaned. Specifically, the processing unit 13 requests the information about the room occupancy rate in the one accommodation facility on the one service day (information as to whether or not the rooms have been booked) from the accommodation management server 6, and acquires the room-occupancy-rate information of the one cleaning-assigned area in the one accommodation facility on the basis of information received from the accommodation management server 6 in response to the request.

Next, on the basis of the room-occupancy-rate information acquired in Step ST105, the processing unit 13 determines a headcount of workers who are necessary for a cleaning service for the one cleaning-assigned area (selected cleaning-assigned area) on the one service day (below, sometimes referred to as “necessary headcount”) (ST110).

For example, at a time of determining the necessary headcount of the workers for the one cleaning-assigned area on the one service day, the processing unit 13 determines the necessary headcount on the basis of the information about normal work hours for the rooms in the one cleaning-assigned area (accommodation facility DB 23), the information about scheduled work hours that are preset for the cleaning service for the one cleaning-assigned area (accommodation facility DB 23), and the room-occupancy-rate information acquired in Step ST105. In this case, for example, the processing unit 13 sums up the normal work hours for the rooms that need to be cleaned, the rooms being indicated by the room-occupancy-rate information, and calculates the necessary headcount on the basis of a quotient obtained by dividing a sum of the work hours (necessary time period on an assumption that one worker cleans all the rooms) by the scheduled work hours.

Note that, if all the normal work hours for each of the rooms are the same as each other, the accommodation facility DB 23 may store a headcount of the workers who are necessary for cleaning all the rooms in the one cleaning-assigned area within the scheduled work hours (maximum necessary headcount). In this case, the processing unit 13 may calculate the necessary headcount on the basis of a product obtained by multiplying the room occupancy rate indicated by the room-occupancy-rate information (a percentage of the number of the rooms that need to be cleaned relative to a total number of the rooms) by the maximum necessary headcount.

After the processing unit 13 has determined in Step ST110 the necessary headcount for the one cleaning-assigned area on the one service day, the processing unit 13 specifies which of one or more workers is engaged in the cleaning service on the one service day (ST115), the specifying being made on the basis of the necessary headcount on the determined-one service day and the work schedule information of workers who belong to the one cleaning-service provider (work management DB 24).

For example, at a time of specifying which of the workers is engaged in the cleaning service for the one cleaning-assigned area that is assigned to the one cleaning-service provider on the one service day, the processing unit 13 selects workers as many as the necessary headcount on the one service day from among the one or more workers who belong to the one cleaning-service provider and who can work on the one service day according to the work schedule information (work management DB 24), the necessary headcount having been determined for the one cleaning-assigned area.

If the one or more workers who are engaged in the cleaning service on the one service day is found by the specifying made by the processing unit 13, the specifying being made for each of the cleaning assigned areas, the processing unit 13 updates the work schedule information of each of the specified workers (work management DB 24) so as to indicate that the workers specified for each of the cleaning assigned areas are scheduled to be engaged in the cleaning service on the one service day.

At a time of selecting in Step ST115 the workers as many as the necessary headcount from among the one or more workers, the processing unit 13 may select the workers on the basis of the attribute information about the cleaning skill (worker DB 22). Specifically, the processing unit 13 may select the workers as many as the necessary headcount from among the workers who can work on the one service day in a manner that predetermined conditions based on the attribute information are satisfied. With this, the workers can be selected in consideration of their cleaning skill, which makes it easy to maintain good cleaning quality.

In addition, at a time of selecting the workers on the basis of the attribute information, the processing unit 13 may make the selection in accordance with ranks of the cleaning skill. Specifically, the processing unit 13 may select the workers so that, at the time of specifying which of the workers is engaged in the cleaning service for the one cleaning-assigned area on the one service day, workers in a predetermined one of the ranks according to the attribute information make up a percentage that is equal to or higher than a predetermined percentage of the necessary headcount on the one service day, the necessary headcount having been determined for the one cleaning-assigned area (necessary headcount determined in Step ST110).

As an example, three ranks “A,” “B,” and “C” are set in a descending order of the cleaning skill, and the attribute information about the cleaning skill indicates to which of these three ranks the workers belongs. As another example, the processing unit 13 selects the workers so that workers in the rank A make up ten percent or more of the necessary headcount determined in Step ST110. In this example, if the necessary headcount is twenty, the processing unit 13 selects the workers so that two or more workers in the rank A are included. With this, workers having high cleaning skill are included at a certain percentage or higher, which makes it easy to maintain cleaning quality.

Note that, at a time of selecting some of a plurality of workers in the same rank of the cleaning skill, the processing unit 13 may make the selection so that work frequencies of the workers are substantially the same as each other (so that variation of the work frequencies is suppressed). For example, the processing unit 13 may assign a predetermined rotating schedule in advance to the plurality of workers in the same rank of the cleaning skill, and may equally select the workers according to this schedule. Alternatively, the processing unit 13 may randomly select some of the plurality of workers in the same rank of the cleaning skill.

After the processing unit 13 has specified in Step ST115 which of the workers is engaged in the cleaning service, the processing unit 13 determines whether or not a shortage of staff of the workers has occurred (ST120). Specifically, the processing unit 13 determines whether or not the headcount of the workers on the one service day, the workers having been specified for the one cleaning-assigned area that has been assigned to the one cleaning-service provider (headcount of the workers specified in Step ST115), is insufficient for the necessary headcount on the one service day, the necessary headcount having been determined for the one cleaning-assigned area (necessary headcount determined in Step ST110). If the processing unit 13 determines that the shortage of the staff of the workers has occurred (YES in ST120), the processing unit 13 registers the information about the absent staff with the service management DB 26 (ST125). The information about the absent staff may be, for example, information that indicates the absent staff in each of the ranks of the cleaning skill indicated by the attribute information.

Even after the processes of Steps ST105 to ST125, if there is another cleaning-assigned area for which these processes of Steps ST105 to ST125 have not yet been executed (YES in ST130), the processing unit 13 selects the other cleaning-assigned area (ST135), and repeats the processes of Steps ST105 to ST125.

If the processing unit 13 have executed all the processes of Steps ST105 to ST125 for all the cleaning assigned areas that are assigned to the one cleaning-service provider on the one service day (NO in ST130), the processing unit 13 determines whether or not there is a surplus worker that is a worker who can work on the one service day and to whom none of cleaning services has been assigned (ST140). If there is a surplus worker (YES in ST140), the processing unit 13 registers information about this surplus worker (such as an identification code of this surplus worker and identification codes of accommodation facilities at which this surplus worker can work) with the surplus worker DB 25.

FIG. 4 is an explanatory flowchart showing an example of a procedure of allotting the surplus worker to resolve a shortage of staff, specifically, showing an example of a procedure of allotting the surplus staff to resolve the shortage of staff on the one service day, the shortage of staff being found by the above-described procedure shown in FIG. 3.

First, the processing unit 13 of the cleaning-service assistance server 1 selects, from among the cleaning-assigned areas, one cleaning-assigned area that is assigned to a certain one cleaning-service provider among the cleaning service providers (ST200), and acquires information about the selected cleaning-assigned area on a certain-one service day among service days, the information being registered with the service management DB 26. On the basis of the information acquired from the service management DB 26, the processing unit 13 determines whether or not a shortage of staff in this cleaning-assigned area has occurred (ST205). If the processing unit 13 determines that the shortage of staff has not occurred (NO in ST205), the processing unit 13 proceeds to Step ST250 described below. Meanwhile, if the processing unit 13 determines that the shortage of staff has occurred (YES in ST205), the processing unit 13 proceeds to Step ST210 described below.

In Step ST210, the processing unit 13 specifies from which of other cleaning-service providers the surplus worker for the one service day when the shortage of staff has occurred can be borrowed (ST210). For example, the processing unit 13 searches the surplus worker DB 25 that has registered surplus workers for the one service day for a surplus worker who can work at an accommodation facility corresponding to the selected cleaning-assigned area. Then, the processing unit 13 specifies to which of the cleaning service providers the surplus worker who has been found by the search belongs. If the other cleaning-service provider from which the surplus worker can be borrowed is not found by the specifying made by the processing unit 13 in Step ST210 (NO in ST215), the processing unit 13 proceeds to Step ST245 described below. Meanwhile, if the other cleaning-service provider is found by the specifying made by the processing unit 13 in Step ST210 (YES in Step ST215), the processing unit 13 proceeds to Step ST220 described below.

In Step ST220, the processing unit 13 transmits a request to borrow the surplus worker to another cleaning-service-provider terminal device 3 among the cleaning-service-provider terminal devices 3 (ST220), the other cleaning-service-provider terminal device 3 being operated by the other cleaning-service provider specified in Step ST210. The processing unit 13 transmits the request to borrow the surplus worker to the other cleaning-service-provider terminal device 3 of the other cleaning-service provider, for example, by issuing a push notification to the cleaning-service-provider terminal device 3 that has logged in to the cleaning-service assistance server 1, or by utilizing other communication means such as e-mail.

After the processing unit 13 has transmitted the request to borrow the surplus worker, the processing unit 13 receives a response to the request from the other cleaning-service-provider terminal device 3 of the other cleaning-service provider. If the processing unit 13 receives, from the other cleaning-service-provider terminal device 3 of the other cleaning-service provider, a response to accept the request to borrow the surplus worker (YES in ST225), the processing unit 13 allots one or more surplus workers who belong to the other cleaning-service provider that has accepted the borrowing request to resolve the shortage of staff, the shortage being determined in Step ST205 (ST230).

In this case, the processing unit 13 updates the work schedule information in the work management DB 24 so that the one or more surplus workers who are accepted to be borrowed on the one service day by the other cleaning-service provider are allotted as the staff in the one cleaning-assigned area, the staff having been determined to be short of on the one service day. Specifically, when the one or more surplus workers are allotted to resolve the shortage of staff for the cleaning work in the one cleaning-assigned area, the processing unit 13 updates the work schedule information (work management DB 24) of the surplus workers to be allotted so as to indicate that the surplus workers to be allotted are scheduled to be engaged in the cleaning service for the one cleaning-assigned area on the one service day.

In addition, the processing unit 13 deletes, from the surplus worker DB 25, information about the surplus workers allotted as the workers in the one cleaning-assigned area on the one service day.

If the processing unit 13 receives in Step ST225 a response to reject the request to borrow the surplus worker (NO in ST225), or if the shortage of staff has not yet been resolved even after Step ST230 (NO in ST235), the processing unit 13 proceeds to Step ST240. In Step ST240, if there is a still another cleaning-service-provider terminal device 3 of a still another cleaning-service provider to which the borrowing request has not yet been transmitted among the other cleaning-service providers specified in Step ST210 (YES in ST240), the processing unit 13 returns to Step ST220 to transmit the borrowing request to the still other cleaning-service provider.

If the processing unit 13 receives the responses to reject the borrowing requests from all the cleaning-service providers specified in Step ST210 (NO in ST240), or if the other cleaning-service provider from which the surplus worker can be borrowed is not found by the specifying made by the processing unit 13 in Step ST210 (NO in ST215), the processing unit 13 transmits a notification of the request to help with the cleaning work to the headquarters terminal device 5 (ST245). Specifically, the processing unit 13 transmits the notification of the help request to the headquarters terminal device 5 via, for example, a push notification or e-mail. After the headquarters terminal device 5 has received the notification of the help request from the cleaning-service-provider terminal device 3, a person in charge in the headquarters verifies this notification, and then takes action to allot some of workers who belong to the headquarters to resolve the shortage of staff.

If the processing unit 13 determines in Step ST235 that the shortage of staff has been entirely resolved by the allotted surplus workers (YES in ST235), of after the processing unit 13 has transmitted in Step ST245 the notification of the request to help with the cleaning work to the headquarters terminal device 5, the processing unit 13 proceeds to Step ST250. In Step ST250, if there is another cleaning-assigned area for which the above-described processes of Steps ST205 to ST245 have not yet been executed (YES in ST250), the processing unit 13 selects the other cleaning-assigned area (ST255), and repeats the processes of Steps ST205 to ST245.

As described above, according to this embodiment, on the basis of the room-occupancy-rate information about rooms in cleaning assigned areas that need to be cleaned on one service day, the necessary headcount of workers who are necessary for cleaning services for the cleaning assigned areas on the one service day is determined.

In addition, on the basis of the determined necessary headcount of the workers on the one service day and on the basis of the work schedule information of workers who belong to a cleaning service provider, which of one or more workers is engaged in the cleaning service on the one service day is specified.

Then, if a headcount of the workers on the one service day, the workers having been specified for one cleaning-assigned area that is assigned to the one cleaning-service provider, is insufficient for the necessary headcount of the workers on the one service day, the necessary headcount having been determined for the one cleaning-assigned area, one or more surplus workers who belong to another cleaning-service provider (workers who can work on the one service day and to whom none of cleaning services has been assigned) are allotted to resolve a shortage of staff for the cleaning work in the one cleaning-assigned area.

This enables the cleaning service providers to each stably secure qualified staff who is determined in accordance with the room occupancy rate even when the necessary headcount of workers who are necessary for cleaning services varies in accordance with variation of the room occupancy rate. With this, the cleaning service providers can properly provide their respective cleaning services. In other words, cleaning service providers that employ a high headcount of workers can send their surplus workers as workers to cleaning assigned areas of other cleaning-service providers. Thus, a decrease of profits due to an increase of labor cost can be suppressed. Meanwhile, cleaning service providers that employ a low headcount of workers can avoid a risk of an excess of scheduled work hours due to incapability of securing qualified staff. In addition, deterioration of cleaning quality can be suppressed.

Further, according to this embodiment, at a time of specifying which of the workers is engaged in the cleaning service for the one cleaning-assigned area that is assigned to the one cleaning-service provider on the one service day, workers as many as the necessary headcount on the one service day are selected on the basis of the attribute information about cleaning skill from among one or more workers who belong to the one cleaning-service provider and who can work on the one service day according to the work schedule information, the necessary headcount having been determined for the one cleaning-assigned area.

With this, the workers who are engaged in cleaning work can be selected from among available workers in consideration of their cleaning skill, which makes it easy to maintain cleaning quality at an appropriate level.

Yet further, according to this embodiment, if the headcount of the workers on the one service day, the workers having been specified for the one cleaning-assigned area that is assigned to the one cleaning-service provider, is insufficient for the necessary headcount of the workers on the one service day, the necessary headcount having been determined for the one cleaning-assigned area, a request to borrow the surplus workers are transmitted to the other cleaning-service-provider terminal device 3 that is operated by the other cleaning-service provider. Then, if a response to accept the request is received from the other cleaning-service-provider terminal device 3 to which the request has been transmitted, the one or more surplus workers who belong to the other cleaning-service provider are allotted to resolve the shortage of staff for the cleaning work in the one cleaning-assigned area.

This enables different cleaning-service providers to smoothly borrow surplus workers from each other.

Note that, the present invention is not limited only to the above-described embodiment, and may be variously modified.

By the above-described procedure shown in the flowchart of FIG. 4, the plurality of cleaning assigned areas which are assigned to the one cleaning-service provider are sequentially selected one by one, and the surplus workers are allotted to resolve shortages of staff. If the headcount of the surplus workers is low, the earlier the cleaning assigned areas are subjected to the allotment of the surplus workers for resolving the shortage of staff, the more likely the surplus workers are appropriately allotted to resolve the shortage of staff. Meanwhile, in accommodation facilities with a plurality of floors, room occupancy rates on upper floors or cleaning quality to be required for these floors may be higher. In such a case, it is desired that the surplus workers be more likely to be appropriately allotted to resolve shortages of staff on the upper floors. In addition, depending on policies of the accommodation facilities, the room occupancy rates may tend to vary regardless of floor numbers of the plurality of floors. In such accommodation facilities, it is desired that the surplus workers be more likely to be appropriately allotted to resolve shortages of staff on floors with higher room-occupancy rates in accordance with the tendency of the respective room-occupancy rates on the floors.

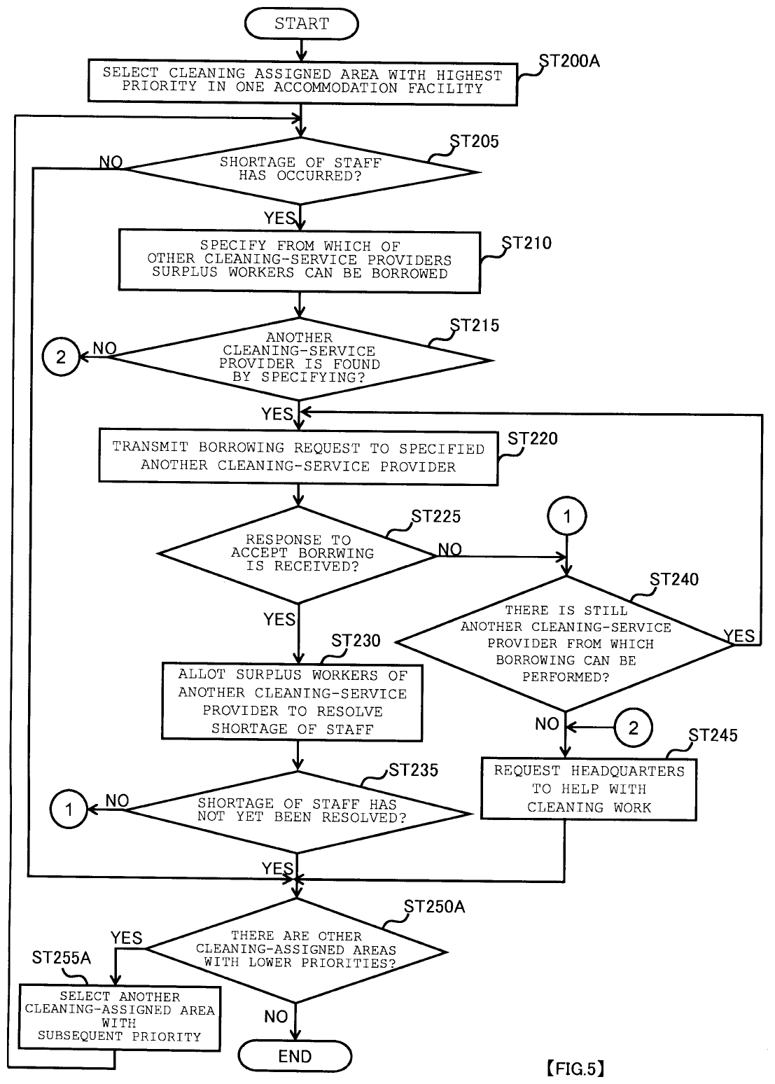

In view of such circumstances, by a procedure of a modification shown in a flowchart of FIG. 5, priorities are set to a plurality of cleaning assigned areas (such as the plurality of floors) in one accommodation facility. For example, higher priorities are set to cleaning assigned areas corresponding to floors with higher room-occupancy rates. Then, the surplus workers are allotted to resolve shortages of staff sequentially from the cleaning assigned areas with the higher priorities.

The flowchart shown in FIG. 5 is obtained by replacing Steps ST200, ST250, and ST255 in the flowchart shown in FIG. 4 with Steps ST200A, ST250A, and ST255A, respectively.

In Step ST200A, the processing unit 13 selects, from among the plurality of cleaning assigned areas in a certain-one accommodation facility, a cleaning assigned area with a highest priority among the priorities. After the processing unit 13 has selected the cleaning assigned area in Step ST200A, the processing unit 13 executes the above-described processes of Steps ST205 to ST245 for this selected cleaning-assigned area. After the processing unit 13 has executed the processes of Steps ST205 to ST245 for this selected cleaning-assigned area, if there are other cleaning-assigned areas with priorities lower than that of the selected cleaning-assigned area (YES in ST250A), the processing unit 13 selects another cleaning-assigned area with a subsequent lower priority (ST255A), and repeats the processes of Step ST205 to ST245.

By the above-described procedure shown in FIG. 5, the allotment for resolving shortages of staff is performed sequentially from cleaning-assigned areas with higher priorities. Thus, surplus workers can be more likely to be appropriately allotted to resolve shortages of staff in the cleaning-assigned areas with the higher priorities.

1-9. (canceled)

10. A cleaning-service assistance server that assists cleaning services which are provided by a plurality of cleaning service providers for rooms in accommodation facilities, the cleaning-service assistance server comprising:
a processing unit; and
a memory that stores an instruction which can be executed by the processing unit,
the processing unit configured for accessing a database that stores work schedule information about work schedules of one or more workers who belong to the plurality of cleaning service providers,
the processing unit executing, in accordance with the instruction stored in the memory, a process comprising:
a first step of acquiring room-occupancy-rate information that is about room occupancy rates in one or more cleaning-assigned areas for which cleaning is assigned respectively to the plurality of cleaning service providers, and that is about, among the rooms in the accommodation facilities, rooms which are in the one or more cleaning-assigned areas, and which need to be cleaned on one service day among service days,
a second step of determining respective headcounts of, among the one or more workers, workers who are necessary for the cleaning services for the one or more cleaning-assigned areas on the one service day, the respective headcounts being determined respectively for the one or more cleaning-assigned areas on a basis of the acquired room-occupancy-rate information,
a third step of specifying which of the one or more workers is engaged in the cleaning services for the one or more cleaning-assigned areas on the one service day, the specifying being made for each of the one or more cleaning-assigned areas on a basis of a corresponding one headcount among the respective headcounts on the one service day, the respective headcounts having been determined respectively for the one or more cleaning-assigned areas, and on a basis of the work schedule information about the work schedules of the one or more workers who belong to the plurality of cleaning service providers, and
a fourth step of allotting surplus workers to resolve a shortage of staff for cleaning work in one cleaning-assigned area among the one or more cleaning-assigned areas if a headcount of one or more workers on the one service day among the one or more workers, the one or more workers on the one service day having been specified for the one cleaning-assigned area, the one cleaning-assigned area having been assigned to one cleaning-service provider among the plurality of cleaning service providers, is insufficient for the corresponding one headcount on the one service day among the respective headcounts, the corresponding one headcount on the one service day having been determined for the one cleaning-assigned area, the surplus workers being another one or more workers who belong to another cleaning-service provider among the plurality of cleaning service providers, who can work on the one service day, and to whom none of the cleaning services has been assigned among the one or more workers who belong to the plurality of cleaning service providers,
priorities being set to a plurality of cleaning-assigned areas in one accommodation facility among the one or more cleaning-assigned areas in the accommodation facilities, and
the processing unit executing the fourth step sequentially from cleaning-assigned areas with higher priorities among the plurality of cleaning-assigned areas with the priorities.

11. The cleaning-service assistance server according to claim 10,
wherein the processing unit is configured for accessing a surplus-worker database that stores information about the surplus workers on the service days, and
wherein the fourth step further includes deleting information about the surplus workers who are allotted as the one or more workers for the one cleaning-assigned area on the one service day from the surplus-worker database, the deleting being done if the surplus workers are allotted to resolve the shortage of staff for the cleaning work in the one cleaning-assigned area on the one service day.

12. The cleaning-service assistance server according to claim 10,
wherein the processing unit is configured for accessing a database that stores attribute information about cleaning skill of the one or more workers, and
wherein the third step further includes selecting one or more workers as many as the corresponding one headcount on the one service day among the respective headcounts, the corresponding one headcount on the one service day having been determined for the one cleaning-assigned area, the selecting being made on a basis of the attribute information, being made from among one or more workers who belong to the one cleaning-service provider and who can work on the one service day according to the work schedule information, and being made at a time of specifying which of the one or more workers is engaged in the cleaning service for the one cleaning-assigned area on the one service day, the one cleaning-assigned area having been assigned to the one cleaning-service provider.

13. The cleaning-service assistance server according to claim 12,
wherein the attribute information includes information about ranks of the cleaning skill of the one or more workers, and
wherein the third step includes selecting the one or more workers so that one or more workers in a predetermined one of the ranks according to the attribute information make up a percentage that is equal to or higher than a predetermined percentage of the corresponding one headcount on the one service day, the corresponding one headcount on the one service day having been determined for the one cleaning-assigned area, the selecting being made at the time of specifying which of the one or more workers is engaged in the cleaning service for the one cleaning-assigned area on the one service day.

14. The cleaning-service assistance server according to claim 10,
wherein the processing unit is configured for accessing a database that stores information about normal work hours that are necessary for cleaning of the rooms which are in the one or more cleaning-assigned areas, and
wherein the second step includes determining the corresponding one headcount on the one service day for the one cleaning-assigned area on a basis of information about normal work hours for rooms which are in the one cleaning-assigned areas in the information about the normal work hours that are necessary for the cleaning of the rooms which are in the one or more cleaning-assigned areas, on a basis of information about scheduled work hours that are preset for the cleaning service for the one cleaning-assigned area, and on the basis of the acquired room-occupancy-rate information.

15. The cleaning-service assistance server according to claim 10, further comprising
a communication unit that is communicable with terminal devices which are operated respectively by the plurality of cleaning service providers,
wherein the fourth step further includes:
transmitting, via the communication unit, a request to borrow the surplus workers to a terminal device which is operated by the other cleaning-service provider among the terminal devices which are operated respectively by the plurality of cleaning service providers if the headcount of the one or more workers on the one service day, the one or more workers on the one service day having been specified for the one cleaning-assigned area, the one cleaning-assigned area having been assigned to the one cleaning-service provider, is insufficient for the corresponding one headcount on the one service day, the corresponding one headcount on the one service day having been determined for the one cleaning-assigned area, and
allotting the surplus workers to resolve the shortage of staff for the cleaning work in the one cleaning-assigned area if a response to accept the request is received, via the communication unit, from the terminal device to which the request has been transmitted, the surplus workers belonging to the other cleaning-service provider.

16. The cleaning-service assistance server according to claim 10,
wherein the third step further includes updating work schedule information of each of the specified one or more workers by updating the work schedule information about the work schedules of the one or more workers who belong to the plurality of cleaning service providers so as to indicate that the one or more workers specified for the one or more cleaning-assigned areas are scheduled to be engaged in the cleaning service on the one service day, the updating being performed if the one or more workers who are engaged in the cleaning services for the one or more cleaning-assigned areas on the one service day are found by the specifying, the specifying being made for each of the one or more cleaning-assigned areas, and
wherein the fourth step further includes updating work schedule information of each of the one or more surplus workers to be allotted by updating the work schedule information about the work schedules of the one or more workers who belong to the plurality of cleaning service providers so as to indicate that the one or more surplus workers to be allotted are scheduled to be engaged in the cleaning service for the one cleaning-assigned area on the one service day, the allotting being performed if the one or more surplus workers are allotted to resolve the shortage of staff for the cleaning work in the one cleaning-assigned area.

17. A cleaning-service assistance method of assisting, by a server, cleaning services which are provided by a plurality of cleaning service providers for rooms in accommodation facilities,
the server configured for accessing a database that stores work schedule information about work schedules of one or more workers who belong to the plurality of cleaning service providers,
the server including:
a first step of acquiring room-occupancy-rate information that is about room occupancy rates in one or more cleaning-assigned areas for which cleaning is assigned respectively to the plurality of cleaning service providers, and that is about, among the rooms in the accommodation facilities, rooms which are in the one or more cleaning-assigned areas, and
which need to be cleaned on one service day among service days,
a second step of determining respective headcounts of, among the one or more workers, workers who are necessary for the cleaning services for the one or more cleaning-assigned areas on the one service day, the respective headcounts being determined respectively for the one or more cleaning-assigned areas on a basis of the acquired room-occupancy-rate information,
a third step of specifying which of the one or more workers is engaged in the cleaning services for the one or more cleaning-assigned areas on the one service day, the specifying being made for each of the one or more cleaning-assigned areas on a basis of a corresponding one headcount among the respective headcounts on the one service day, the respective headcounts having been determined respectively for the one or more cleaning-assigned areas, and on a basis of the work schedule information about the work schedules of the one or more workers who belong to the plurality of cleaning service providers, and
a fourth step of allotting surplus workers to resolve a shortage of staff for cleaning work in one cleaning-assigned area among the one or more cleaning-assigned areas if a headcount of one or more workers on the one service day among the one or more workers, the one or more workers on the one service day having been specified for the one cleaning-assigned area, the one cleaning-assigned area having been assigned to one cleaning-service provider among the plurality of cleaning service providers, is insufficient for the corresponding one headcount on the one service day among the respective headcounts, the corresponding one headcount on the one service day having been determined for the one cleaning-assigned area, the surplus workers being another one or more workers who belong to another cleaning-service provider among the plurality of cleaning service providers, who can work on the one service day, and to whom none of the cleaning services has been assigned among the one or more workers who belong to the plurality of cleaning service providers,
priorities being set to a plurality of cleaning-assigned areas in one accommodation facility among the one or more cleaning-assigned areas in the accommodation facilities, and
the server executing the fourth step sequentially from cleaning-assigned areas with higher priorities among the plurality of cleaning-assigned areas with the priorities.

18. A computer-readable recording medium that records a cleaning-service assistance program for causing a server to execute a process of assisting cleaning services which are provided by a plurality of cleaning service providers for rooms in accommodation facilities,
the server configured to access a database that stores work schedule information about work schedules of one or more workers who belong to the plurality of cleaning service providers,
the process that the cleaning-service assistance program causes the server to execute including:
a first step of acquiring room-occupancy-rate information that is about room occupancy rates in one or more cleaning-assigned areas for which cleaning is assigned respectively to the plurality of cleaning service providers, and that is about, among the rooms in the accommodation facilities, rooms which are in the one or more cleaning-assigned areas, and which need to be cleaned on one service day among service days,
a second step of determining respective headcounts of, among the one or more workers, workers who are necessary for the cleaning services for the one or more cleaning-assigned areas on the one service day, the respective headcounts being determined respectively for the one or more cleaning-assigned areas on a basis of the acquired room-occupancy-rate information,
a third step of specifying which of the one or more workers is engaged in the cleaning services for the one or more cleaning-assigned areas on the one service day, the specifying being made for each of the one or more cleaning-assigned areas on a basis of a corresponding one headcount among the respective headcounts on the one service day, the respective headcounts having been determined respectively for the one or more cleaning-assigned areas, and on a basis of the work schedule information about the work schedules of the one or more workers who belong to the plurality of cleaning service providers, and
a fourth step of allotting surplus workers to resolve a shortage of staff for cleaning work in one cleaning-assigned area among the one or more cleaning-assigned areas if a headcount of one or more workers on the one service day among the one or more workers, the one or more workers on the one service day having been specified for the one cleaning-assigned area, the one cleaning-assigned area having been assigned to one cleaning-service provider among the plurality of cleaning service providers, is insufficient for the corresponding one headcount on the one service day among the respective headcounts, the corresponding one headcount on the one service day having been determined for the one cleaning-assigned area, the surplus workers being another one or more workers who belong to another cleaning-service provider among the plurality of cleaning service providers, who can work on the one service day, and to whom none of the cleaning services has been assigned among the one or more workers who belong to the plurality of cleaning service providers,
priorities being set to a plurality of cleaning-assigned areas in one accommodation facility among the one or more cleaning-assigned areas in the accommodation facilities, and
the cleaning-service assistance program causing the server to execute the fourth step sequentially from cleaning-assigned areas with higher priorities among the plurality of cleaning-assigned areas with the priorities.
